(19) United States
(12) Patent Application Publication
(10) Pub. No.: US 2025/0363803 A1
(43) Pub. Date: Nov. 27, 2025

(54) CPU-Based Computer-Vision Techniques for A Smart Cart System

(71) Applicant: Maplebear Inc., San Francisco, CA (US)

(72) Inventors: David Scott, New York, NY (US); Mehdi Nikkhah, San Jose, CA (US); Youming Luo, Shanghai (CN); Faraz Shamshirdar, Vancouver (CA); Xiao Zhou, Shanghai (CN); Lidan Wang, Shanghai (CA); Qi Wang, Port Washington, NY (US); Christopher Paiano, Winter Springs, FL (US)

(21) Appl. No.: 19/216,349

(22) Filed: May 22, 2025

Related U.S. Application Data
(60) Provisional application No. 63/650,479, filed on May 22, 2024.

(51) Int. Cl. G06V 20/50; G06N 20/00; G06V 10/70; G06V 10/764; G06V 30/19

(52) U.S. Cl. CPC G06V 20/50; G06N 20/00; G06V 10/764; G06V 10/87; G06V 30/19

(57) ABSTRACT

A smart shopping cart identifies items using cameras and sensors. The cart captures images of items within its storage area and applies machine-learning models, such as a barcode detection model, an OCR model, and an image embedding model, to generate identifier predictions. These predictions are processed using an efficient selection algorithm, which may involve majority voting, weighted voting, or linear regression, to select the most accurate identifier. The cart updates its display and user interface with the identified item. The process may be performed primarily by the CPU to enhance computational efficiency, avoiding the latency associated with GPU data transfer. Additional techniques, such as circular buffers and frame skipping, are employed to further optimize resource usage.

### CROSS REFERENCE TO RELATED APPLICATIONS

This application claims the benefit of U.S. Provisional Patent Application Ser. No. 63/650,479, filed May 22, 2024, which is incorporated by reference herein in its entirety.

### BACKGROUND

A smart shopping cart may use cameras coupled to the shopping cart to identify items that are placed in the cart's storage area. An on-board computing system of the smart shopping cart applies computer-vision techniques to images or video frames captured by the cameras to identify items in the shopping cart. For example, the on-board computing system may use trained machine-learning models to identify machine-readable labels, text characters, or even visual features of the items themselves to identify which items a user is adding to a shopping cart.

Traditionally, these kinds of machine-learning models or computer-vision techniques are executed on a graphics processing unit (GPU). GPUs are designed to perform numerous simple computations in parallel while central processing units (CPUs) are designed to perform complex tasks but in series. Thus, GPUs tend to outperform CPUs when executing computer vision techniques, which generally require simpler computations performed on all pixels of an image, or when executing machine-learning models, which generally require many small sums and multiplications using the set of parameters of the models.

However, the CPU initially receives images or other data that is used by the GPU when executing these computer vision techniques or machine-learning models, and the CPU must pass the images and other data to the GPU through a pipeline between the units. This introduces a latency in the execution of the models and techniques on the GPU because the needed data must pass from the CPU to the GPU through the pipeline. A smart shopping cart identifying items using computer-vision models requires that the item be identified quickly (e.g., less than 500 ms) to ensure an effective user experience. The latency in passing the data from the CPU to the GPU may exceed any performance gains of using the GPU.

### SUMMARY

To address these issues, a smart shopping cart uses a CPU to process images captured from an on-board camera rather than a GPU to achieve better overall throughput. The shopping cart receives a sequence of images from cameras coupled to the shopping cart and applies a background removal model to the received images. The background removal model is a machine-learning model that identifies and removes backgrounds from images, leaving only the main subject or foreground of the image. The background removal model may change pixels of the image that correspond to the background to black pixels (e.g., with RGB values of (0, 0, 0)).

The smart shopping cart uses the background-removed images to determine whether an action is occurring in the images. Specifically, the smart shopping cart computes what proportion of each image is identified as the background (e.g., what proportion of each image is black pixels) and compares that proportion to a threshold. If the proportion exceeds a threshold value, the smart shopping cart determines that there is no action occurring in the image. However, if the proportion of background in the image does not exceed the threshold, then the smart shopping cart determines that an action is occurring in the image.

The smart shopping cart generates an image embedding for images where the smart shopping cart determines that an action is occurring. The smart shopping cart may use an embedding model stored on the shopping cart to generate the image embeddings. The smart shopping cart uses a classifier (or any machine-learning model or any algorithm) to identify which item is represented in the image based on the generated image embedding. For example, the classifier may compare the image embedding to embeddings for images of items to identify which item is most likely represented by the image. In some embodiments, the classifier compares the image embeddings to text prompt embeddings that describe an item generated using a text prompt embedding model (e.g., a large language model).

The smart shopping cart uses a voting classifier technique to use the item identifiers predicted for each image of a sequence of images in which the smart shopping cart detected an action. For example, the smart shopping cart may have each sequence of images vote for which item is represented by the image and may weight each of the images based on how recently they were captured. The smart shopping cart generates an item identifier prediction for an item added to the shopping cart based on the voting classifier technique and adds the corresponding to a maintained list of items in the cart.

In some embodiments, the smart shopping cart stores the sequence of images in a circular buffer while the images are being processed. The circular buffer may be made available to multiple applications operating on the smart shopping cart. The smart shopping cart uses the images in the circular buffer as images that may be used for the voting classifier technique.

As noted above, the smart shopping cart uses the CPU for the steps described above to minimize or eliminate the I/O cost of performing the processing steps on the GPU. The CPU may be used for all of the steps, or the CPU may perform a subset (e.g., applying the background removal model, classifying each image, or executing the voting classifier technique).

### BRIEF DESCRIPTION OF THE DRAWINGS

FIG. 1 illustrates an example system environment for a smart shopping cart system, in accordance with one or more illustrative embodiments.

FIG. 2 is a flowchart for an example method of identifying an item by applying an efficient selection algorithm to predictions generated by multiple models, in accordance with some embodiments.

FIG. 3 illustrates an example data flow for applying a set of machine-learning models to an image, in accordance with some embodiments.

### DETAILED DESCRIPTION

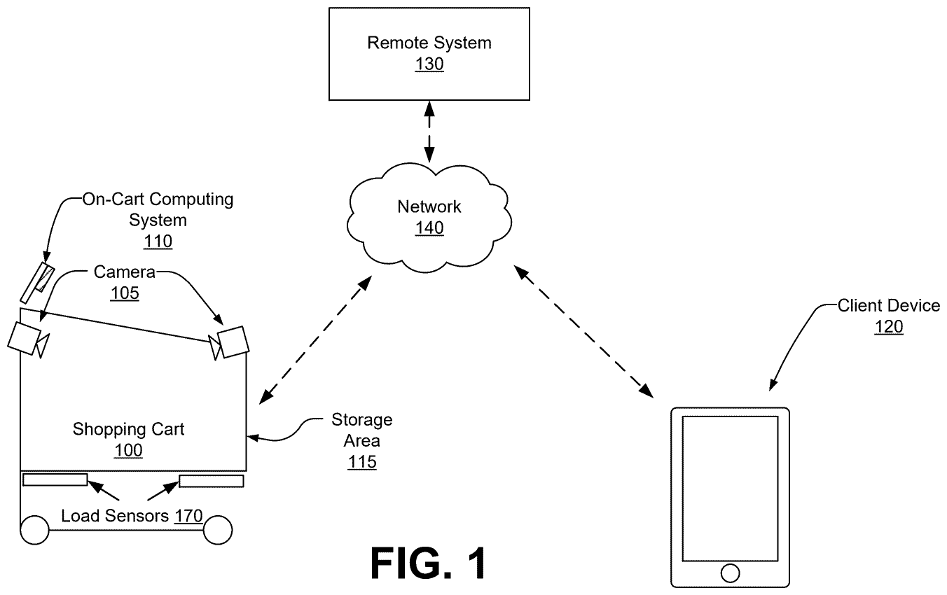

FIG. 1 illustrates an example system environment for a smart shopping cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface 110 that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100. In some embodiments, the shopping cart only has a single camera 105.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the shopping cart generates a machine-readable label that identifies or describes the shopping list listing the items in the shopping cart. The shopping cart may display that machine-readable label and, when that label is scanned by a cashier, the remote system 130 may determine which items are on the shopping list using the machine-readable label and facilitate a checkout process accordingly.

In some embodiments, the remote system 130 establishes a session for a user to associate the user's actions with the shopping cart 100 to that user. The user may establish the session by inputting a user identifier (e.g., phone number, email address, username, loyalty identifier, etc.) into a user interface of the remote system 100. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

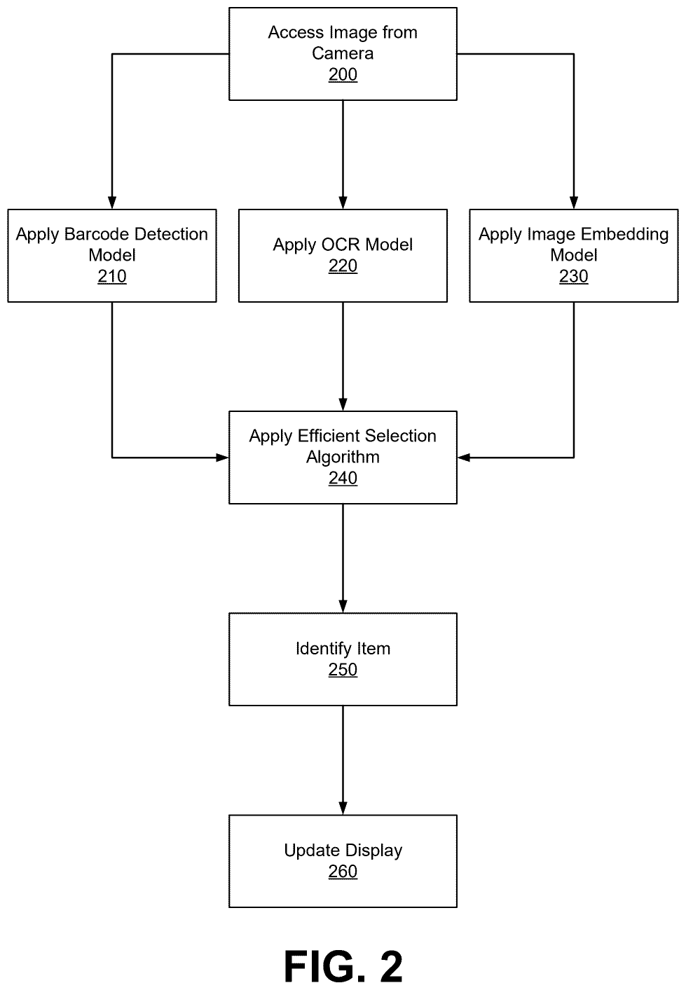

FIG. 2 is a flowchart for an example method of identifying an item by applying an efficient selection algorithm to predictions generated by multiple models, in accordance with some embodiments. Alternative embodiments may include more, fewer, or different steps from those illustrated in FIG. 2 and the steps may be performed in a different order from that illustrated in FIG. 2. Furthermore, the steps of FIG. 2 are described as being performed by a computing system of a smart shopping cart. However, the steps may be performed individually or jointly by a smart shopping cart and a remote system.

The shopping cart accesses 200 an image captured by a camera coupled to the shopping cart. The image may depict an item located within a storage area of the shopping cart or may depict an item located nearby the shopping cart, depending on the orientation of the camera. In some embodiments, the shopping cart accesses multiple images captured by multiple cameras at approximately the same time. These multiple images may depict items in the storage area of the shopping cart from different angles. In some embodiments, the shopping cart also accesses sensor data captured at approximately the same time as the accessed image. For example, the shopping cart may access load data captured by a load sensor or proximity data captured by a proximity sensor.

The shopping cart applies a set of machine-learning models to the accessed image to generate identifier predictions for the image. For example, the shopping cart may apply a barcode detection model 210, an optical character recognition (OCR) model 220, and an image embedding model 230 to the image to generate identifier predictions. These models are described in further detail above. These identifier predictions are predictions of item identifiers for items that a user may add to a shopping cart. For example, each item identifier may be a stock keeping unit code, a price lookup unit code, or an identifier maintained by an online system (e.g., an online concierge system) for identifying an item. In some embodiments, the machine-learning models also generate confidence scores for each corresponding item identifier. A confidence score represents a predicted likelihood that the corresponding identifier prediction is accurate.

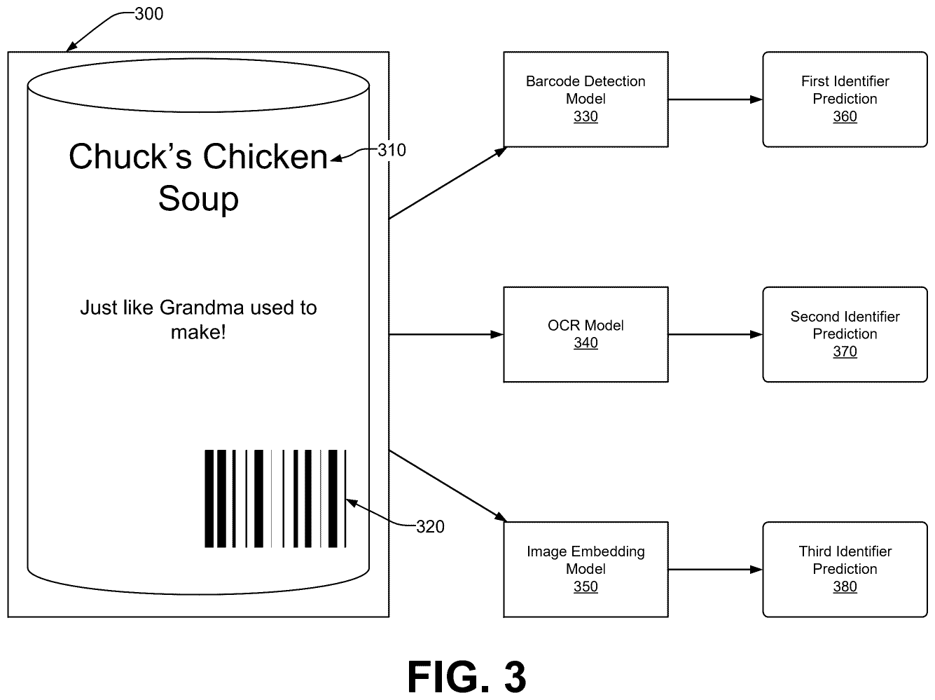

FIG. 3 illustrates an example data flow for applying a set of machine-learning models to an image, in accordance with some embodiments. The image 300 depicts an item, including text 310 on the item and a barcode 320 that are affixed to the item. The shopping cart applies the barcode detection model 330 to the image to generate a first identifier prediction 360, applies the OCR model 340 to the image to generate a second identifier prediction 370, and the image embedding model 350 to the image to generate a third identifier prediction 380.

The shopping cart applies 240 an efficient selection algorithm to select one of the identifier predictions to use for identifying the item depicted in the image. An efficient selection algorithm is an algorithm that requires minimal computational resources to perform. For example, the efficient selection algorithm may be a simple majority algorithm that selects the identifier prediction that is generated by a majority of the models (i.e., two out of three). Alternatively, the efficient selection algorithm may apply a weighted voting technique, where each model's “vote” for an identifier prediction is weighted by some metric. For example, each vote may be weighted based on a corresponding confidence score for the identifier prediction or based on a hierarchy of the machine-learning models. In some embodiments, the hierarchy prioritizes the models in the following order from highest priority to lowest priority: the barcode detection model, the OCR model, the image embedding model. In some embodiments, the efficient selection algorithm applies a linear regression to the identifier predictions from the machine-learning models to select one of the identifier predictions.

The shopping cart identifies 250 the item depicted in the image based on the selected identifier prediction and adds the identified item to the user's shopping list. In some cases, the shopping cart may use a load sensor coupled to the shopping cart to weigh the identified item to determine a quantity of the item added to the shopping cart. The shopping cart updates 260 a display of the shopping cart to indicate that the item has been identified. The display may be updated to include the identified item in the user's shopping list. The shopping cart also may update a user interface on a client device associated with the user, where the client device is in communication with the smart shopping cart.

While the description above primarily relates to using three specific machine-learning models, in alternative embodiments, the shopping cart may use more, fewer, or different machine-learning models from the specific examples provided above.

As noted above, this process may be performed exclusively by a CPU of a computing system on the smart shopping cart. That is, the above process may be performed such that captured images or sensor data is primarily or entirely processed by a CPU rather than a GPU. The CPU may be part of a main computing console of the shopping cart that directly receives images or sensor data that is captured by the cameras or sensors of the shopping cart. The smart shopping cart may include a GPU that is separate from the main computing console of the smart shopping cart. For example, the GPU may be part of a separate computing board from the main computing console. Thus, by executing the process on the CPU, the smart shopping cart can achieve overall computing efficiency by avoiding the transfer of data between a main computing console and a GPU.

The smart shopping cart may employ additional techniques to limit the usage of the computational resources of the above-described process for identifying items. For example, the smart shopping cart may use a circular buffer of images or sensor data for the item identification models that the smart shopping cart uses. This circular buffer may be one that is used by other processes being executed by the smart shopping cart. For example, the circular buffer may store images or other sensor data for a process of detecting motion within captured video data, a process for displaying captured images on a display of the smart shopping cart, or a process for removing identifying information from images. Each of these processes may have access to the circular buffer and thus the data stored in the circular buffer does not need to be stored multiple times for multiple processes.

Additionally, the smart cart system may apply a frame skipping technique to captured image frames to reduce the computational load on the smart cart system. For example, the smart shopping cart may only apply the item identification machine-learning models to a subset of the images captured by the cameras of the smart shopping cart. In some embodiments, the smart shopping cart only applies the machine-learning models to a subset of a sequence of captured images that are located at some interval within the sequence (e.g., every nth image captured by the cameras, for some constant value of n). Alternatively, the smart shopping cart may dynamically select which proportion or which subset of captured images to apply the machine-learning models to. In some embodiments, the smart shopping cart may apply different subsets of the machine-learning models to different images.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method, performed by a computing system coupled to a shopping cart, the computing system comprising a central processing unit and a non-transitory computer-readable medium, comprising:
storing, on the non-transitory computer-readable medium of the computing system coupled to the shopping cart, parameters for a plurality of machine-learning models, wherein each machine-learning model is configured to predict an item identifier for an item depicted in a image;
accessing, by the central processing unit of the computing system, an image captured by a camera coupled to the computing system, wherein the image depicts an item;
applying, by the central processing unit of the computing system, each of the plurality of machine-learning models to the accessed image to generate a plurality of predictions, wherein each of the plurality of predictions is a predicted item identifier for the item depicted in the image;
selecting, by the central processing unit of the computing system, a prediction of the plurality of predictions by inputting the plurality of predictions to a selection process executed by the central processing unit, wherein the selection process comprises a set of rules for selecting a prediction of the plurality of predictions;
generating, by the central processing unit of the computing system, content based on the predicted item identifier of the selected prediction; and
updating, by the central processing unit of the computing system, a display of the computing system to include the generated content.

2. The method of claim 1, wherein the computing system comprises a main computing console communicatively coupled to the camera of the computing system, wherein the main computing console comprises the central processing unit.

3. The method of claim 1, wherein the plurality of machine-learning models comprises a barcode model that is trained to identify an item identifier encoded in a barcode depicted in an image.

4. The method of claim 1, wherein the plurality of machine-learning models comprises an optical character recognition model that is trained to identify text characters depicted within an image.

5. The method of claim 1, wherein the plurality of machine-learning models comprises an image embedding model that is trained to generate an image embedding for images for comparison to stored image embeddings of items.

6. The method of claim 1, wherein the image is accessed from a circular buffer of the computing system.

7. The method of claim 1, wherein accessing the image comprises:
accessing a sequence of images captured by the camera; and
selecting a subset of the sequence of images at an interval within the sequence.

8. The method of claim 1, further comprising:
executing the selection process by selecting a majority prediction of the plurality of predictions.

9. The method of claim 1, further comprising:
executing the selection process by:
weighting each of the plurality of predictions; and
applying a weighted voting technique to the plurality of predictions based on the weightings of the plurality of predictions.

10. A non-transitory computer-readable medium storing instructions that, when executed by a computing system coupled to a shopping cart, the computing system comprising a central processing unit, cause the computing system to perform operations comprising:
storing, on the non-transitory computer-readable medium of the computing system coupled to the shopping cart, parameters for a plurality of machine-learning models, wherein each machine-learning model is configured to predict an item identifier for an item depicted in a image;
accessing, by the central processing unit of the computing system, an image captured by a camera coupled to the computing system, wherein the image depicts an item;
applying, by the central processing unit of the computing system, each of the plurality of machine-learning models to the accessed image to generate a plurality of predictions, wherein each of the plurality of predictions is a predicted item identifier for the item depicted in the image;
selecting, by the central processing unit of the computing system, a prediction of the plurality of predictions by inputting the plurality of predictions to a selection process executed by the central processing unit, wherein the selection process comprises a set of rules for selecting a prediction of the plurality of predictions;
generating, by the central processing unit of the computing system, content based on the predicted item identifier of the selected prediction; and
updating, by the central processing unit of the computing system, a display of the computing system to include the generated content.

11. The computer-readable medium of claim 10, wherein the computing system comprises a main computing console communicatively coupled to the camera of the computing system, wherein the main computing console comprises the central processing unit.

12. The computer-readable medium of claim 10, wherein the plurality of machine-learning models comprises a barcode model that is trained to identify an item identifier encoded in a barcode depicted in an image.

13. The computer-readable medium of claim 10, wherein the plurality of machine-learning models comprises an optical character recognition model that is trained to identify text characters depicted within an image.

14. The computer-readable medium of claim 10, wherein the plurality of machine-learning models comprises an image embedding model that is trained to generate an image embedding for images for comparison to stored image embeddings of items.

15. The computer-readable medium of claim 10, wherein the image is accessed from a circular buffer of the computing system.

16. The computer-readable medium of claim 10, wherein accessing the image comprises:
accessing a sequence of images captured by the camera; and
selecting a subset of the sequence of images at an interval within the sequence.

17. The computer-readable medium of claim 10, the operations further comprising:
executing the selection process by selecting a majority prediction of the plurality of predictions.

18. The computer-readable medium of claim 10, the operations further comprising:
executing the selection process by:
weighting each of the plurality of predictions; and
applying a weighted voting technique to the plurality of predictions based on the weightings of the plurality of predictions.

19. A shopping cart system comprising a shopping cart and a computing system coupled to the shopping cart, wherein the computing system comprises a central processing unit and a non-transitory computer-readable medium storing instructions that, when executed by the computing system, cause the computing system to perform operations comprising:
storing, on the non-transitory computer-readable medium of the computing system coupled to the shopping cart, parameters for a plurality of machine-learning models, wherein each machine-learning model is configured to predict an item identifier for an item depicted in a image;
accessing, by the central processing unit of the computing system, an image captured by a camera coupled to the computing system, wherein the image depicts an item;
applying, by the central processing unit of the computing system, each of the plurality of machine-learning models to the accessed image to generate a plurality of predictions, wherein each of the plurality of predictions is a predicted item identifier for the item depicted in the image;
selecting, by the central processing unit of the computing system, a prediction of the plurality of predictions by inputting the plurality of predictions to a selection process executed by the central processing unit, wherein the selection process comprises a set of rules for selecting a prediction of the plurality of predictions;
generating, by the central processing unit of the computing system, content based on the predicted item identifier of the selected prediction; and
updating, by the central processing unit of the computing system, a display of the computing system to include the generated content.

20. The shopping cart system of claim 19, wherein the plurality of machine-learning models comprises a barcode model that is trained to identify an item identifier encoded in a barcode depicted in an image.
